(19) United States
(12) Patent Application Publication
(10) Pub. No.: US 2012/0204379 A1
(43) Pub. Date: Aug. 16, 2012

(54) NOZZLE-BASED AEROSOL CLEANER FOR OPTICAL CONNECTORS

(76) Inventors: Micah C. Isenhour, Lincolnton, NC (US); Dennis M. Knecht, Hickory, NC (US); James P. Luther, Hickory, NC (US)

(21) Appl. No.: 13/368,886

(22) Filed: Feb. 8, 2012

Related U.S. Application Data
(60) Provisional application No. 61/441,942, filed on Feb. 11, 2011.

(51) Int. Cl. A47L 5/02; B05B 1/00

(52) U.S. Cl. 15/405; 239/589

(57) ABSTRACT

A system for cleaning internal optical components of a fiber optic connector includes a source of cleaning medium such as compressed air connected to a cleaning tip. The cleaning tip has a body and a tongue that is configured to be inserted into the end of the fiber optic connector. Nozzles are formed on the tongue. The tongue may have features to open shutters and/or other protective features in the connector that normally protect the internal optical components. When the tongue is inserted into the end of the connector, the nozzles are positioned adjacent optical components to be cleaned and compressed air is delivered through the nozzles to clean the components. Backwash can be exhausted around the tongue or through the tongue to eject contaminants from the fiber optic connector.

### PRIORITY APPLICATION

This application claims the benefit of priority under 35 U.S.C. §119 of U.S. Provisional Application No. 61/441,942, filed on Feb. 11, 2011, the content of which is relied upon and incorporated herein by reference in its entirety.

### BACKGROUND

The present disclosure generally relates to electronic connectors, and in particular to the cleaning and maintenance of electronic optical connectors, and is particularly applicable to consumer electronic connectors.

The science of fiber optics is applicable to various fields of technology and is often applied to the transmission of communication signals. Individual optical fibers, which each act as a waveguide for directing light from one end of the fiber to the other, can be bundled together to form a fiber optic cable. As the use of fiber optics migrates into numerous consumer electronics applications, such as connecting computer peripherals (USB and Firewire cables for example), there will be a consumer driven expectation for cables having improved performance and a broad range of use and for cable connectors that are at least as reliable as traditional wire cable connectors. As a specific example, as the Intel® USB 4 connector design continues to mature, the ability to reach the optical surfaces in the connector is becoming increasingly difficult because they are buried deep within the connector and may be protected with shutters and other protective features.

Benefits of optical fiber include extremely wide bandwidth and low noise operation. Fiber optic networks often include separated interconnection points linking fiber optic cables and connecting such cables to devices to provide “live fiber” from one connection point to another connection point. For this purpose, fiber optic cables generally terminate in male and/or female connectors that can be coupled to the connectors of like fiber optic cables or to electronic equipment to complete and optical connection.

At the interconnections within the connectors, light exiting the core of the optical fiber or fibers of a cable is immediately introduced into a core of the optical fiber or fibers within an adjacent connected fiber optic connector. If two cores are misaligned, then much of the optical signal is not exchanged from the core of the first fiber optic cable to the core of the second fiber optic cable. This results in signal degradation at the interconnections. Furthermore, and more salient to the present disclosure, if a piece or pieces of debris is caught in either of the fiber optic connectors, then it is likely that little or no optical signal will be exchanged from the core of the first fiber cable to the core of the second fiber optic cable, particularly if the debris has a size that is approximately the same size or larger than the size of the terminating surfaces of the fiber optic cables within the connector. Unlike wire cable connectors, dust, dirt and other contaminants are a particular problem in optical connections because they interfere with the passage of light from one fiber to another and the information embedded in the light is not or is poorly transmitted. Fiber optic connectors must therefore be kept clean to ensure long life and to minimize transmission loss and optical return loss at connection points. A single dust particle caught between two connectors can cause significant signal loss. Dust particles as small as 1 micrometer (μm) in diameter at a connection point can significantly degrade performance. Particles 8 μm in diameter or larger at a connection point can cause a complete failure of an optical system.

In addition, dust particles within optical connectors can scratch optical components, such as lens and mirrors, resulting in permanent damage. What is needed is a simple and reliable apparatus for cleaning and inspecting optical connectors, particularly in locations where the connectors are not easily accessible.

What is also needed is a simple and inexpensive mechanical system to position a cleaning device close to a connector so the optical components of connector can be adequately cleaned.

An additional need is for fiber optic connector cleaning options that work with the deeply buried, highly shrouded, shuttered optical components within recent connector and receptacle designs. It is to these and other needs that the present disclosure is primarily directed.

### SUMMARY

Briefly described, in one embodiment, a cleaning tip is disclosed for strategically delivering compressed air or another cleaning medium to an optical connector, such as an optical USB connector for example, to purge the connector of dust and debris that might interfere with the exchange of an optical signal. The cleaning tip may have a body with an orifice arranged near a first end of the body for receiving compressed air or other cleaning medium from a source such as an aerosol can. A generally flat tongue extends from a second end of the body, which is opposite the first end of the body and is sized to be inserted into the end of an optical connector or receptacle. At least one nozzle arranged near a first end of the tongue is configured to deliver compressed air at strategic locations to clean optical components within the connector. A passageway for delivering compressed air to the nozzle or nozzles is arranged within the body and tongue and extends from the first end of the body to the first end of the tongue. In use, the cleaning tip may be attached to the end of a small tube that, in turn, is connected to the source of compressed air or other cleaning medium. Cleaning medium can thus be selectively delivered through the tube to the cleaning tip and expelled through the nozzles of the tip. The tongue can thus be inserted into the end of an optical connector or receptacle where the compressed air or other cleaning medium blows out debris and cleans optical components within the connector.

Also disclosed is a cleaning system for cleaning optical components of an optical connector. The cleaning system includes a cleaning tip as described herein, a supply of compressed air or other gas or cleaning medium to clean the optical components and a means of fluidly and selectively connecting the supply of compressed air with the cleaning tip.

Additional features and advantages will be set forth in the detailed description which follows, and in part will be readily apparent to those skilled in the art from that description and the accompanying drawings, or recognized by practicing the embodiments described herein.

It is to be understood that both the foregoing summary and the following detailed description are merely exemplary of preferred embodiments.

### BRIEF DESCRIPTION OF THE DRAWINGS

The drawing figures emphasize the general principles of the present disclosure and are not necessarily drawn to scale. Reference characters designating corresponding components are repeated as necessary throughout the figures for the sake of consistency and clarity.

FIG. 1 is an isometric view of a typical optical connector used in the consumer electronic industry, which may be a USB connector in this exemplary embodiment.

FIG. 2 is a cross sectional view of the optical connector of FIG. 1.

FIG. 3 is an isometric view of a cleaning system according to an embodiment of the disclosure showing a detailed view of an embodiment of the cleaning tip.

FIG. 4 is an isometric view of the cleaning system of FIG. 3 showing the cleaning tip inserted within a male optical connector, in this example a USB connector.

FIG. 5 is an isometric view of the cleaning system of FIG. 3 showing the cleaning inserted within a female optical connector, in this example a USB connector.

FIG. 6 is an isometric view of the cleaning system of FIG. 3 showing the relationship of the cleaning tip to internal optical components of an optical connector within which the tip is inserted.

### DETAILED DESCRIPTION

The present disclosure is directed to a cleaning tip and a cleaning system for use with an electronic optical connector. Although disclosed primarily within the context of a cleaning tip and a cleaning system for a consumer electronic optical connector, and more specifically a USB optical connector, the skilled artisan will recognize that the principles of the present disclosure are not so limited but extend to any type of fiber optic connector susceptible to dirt, dust or other contaminants that may build up internal to the connector and effect performance. Indeed, the methodology may also be applied to traditional wire cable connectors.

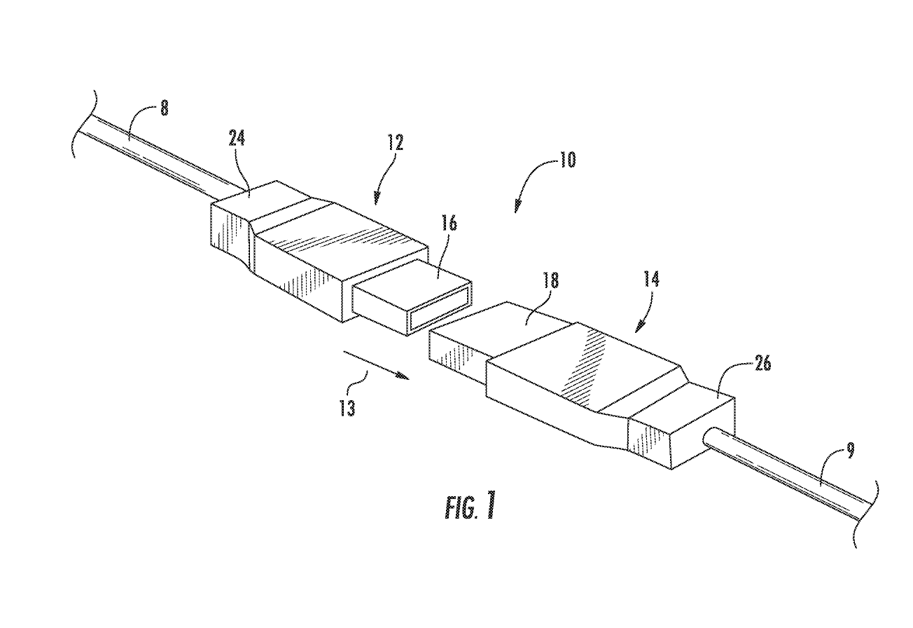

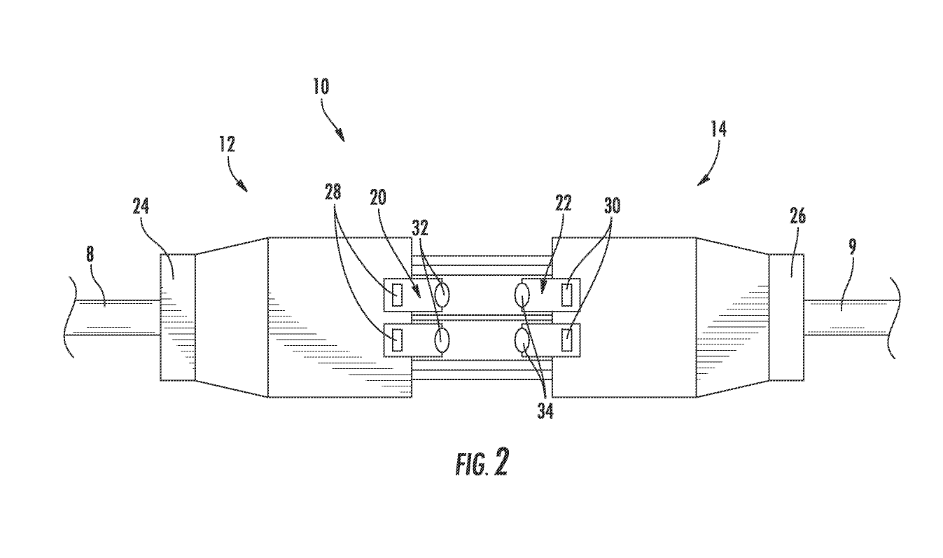

FIGS. 1 and 2 are an isometric view a cross sectional view, respectively, of a typical consumer electronic optical USB connection 10 showing a male connector 12 and a female connector 14. FIG. 1 shows a condition in which the male connector 12 and the female connector are disconnected. By inserting the male connector 12 into the female connector 14 in the direction of an arrow 13, an optical connection is made between two fiber optic cables 8 and 9 that are terminated by the connectors. Alternatively, one of the connectors, usually the female may be a receptacle built into a component such as a computer or peripheral device.

The male connector 12 may include optical components 20 disposed within a case 16 and the female connector 14 may include optical components 22 disposed within a case 18. When the male connector 12 and the female connector 14 are connected together, the optical components 20 of the male connector 12 and the optical components 22 of the female connector 14 are opposed to and aligned with each other for proper transmission of data across the junction. Generally, the fiber optic connector 10 may transmit optical signals encoded with data in the single direction of the arrow 13 or, more likely, in both directions (bidirectional), by optical transmission. For example, a fiber optic cable 8 may be connected to a peripheral device (not shown) and a fiber optic cable 9 of connector 14 may be connected to a personal computer (not shown) in order to transmit data from the peripheral device to the personal computer and vice versa. Such optical transmission enables high-speed data communication rates of several tens to several hundreds times that of a conventional wire cable, thereby achieving, for example, data transmitting speeds of from about 100 megabits per second (Mbps) up to about 10 gigabits per second (Gbps).

The optical components 20 disposed in the male connector 12 may include, for example, a light emitting surface 28, and one or more lenses 32 or other optical components. The optical components 22 disposed in the female connector 12 may include, for example, a light receiving surface 30 and one or more lenses 34. The light receiving surface 30 may receive an optical signal from the light emission surface 28 through the lens 34 for transmission through the fiber optic cable 8. Although not illustrated, the connectors may further include additional lenses and at least one mirror as elements of the optical components. Given the large quantities of data transmitted by optical transmission, it is important that all the optical components of the connector (e.g. optical components 20, 22) are clean and free of contaminants, which at least includes dirt and dust.

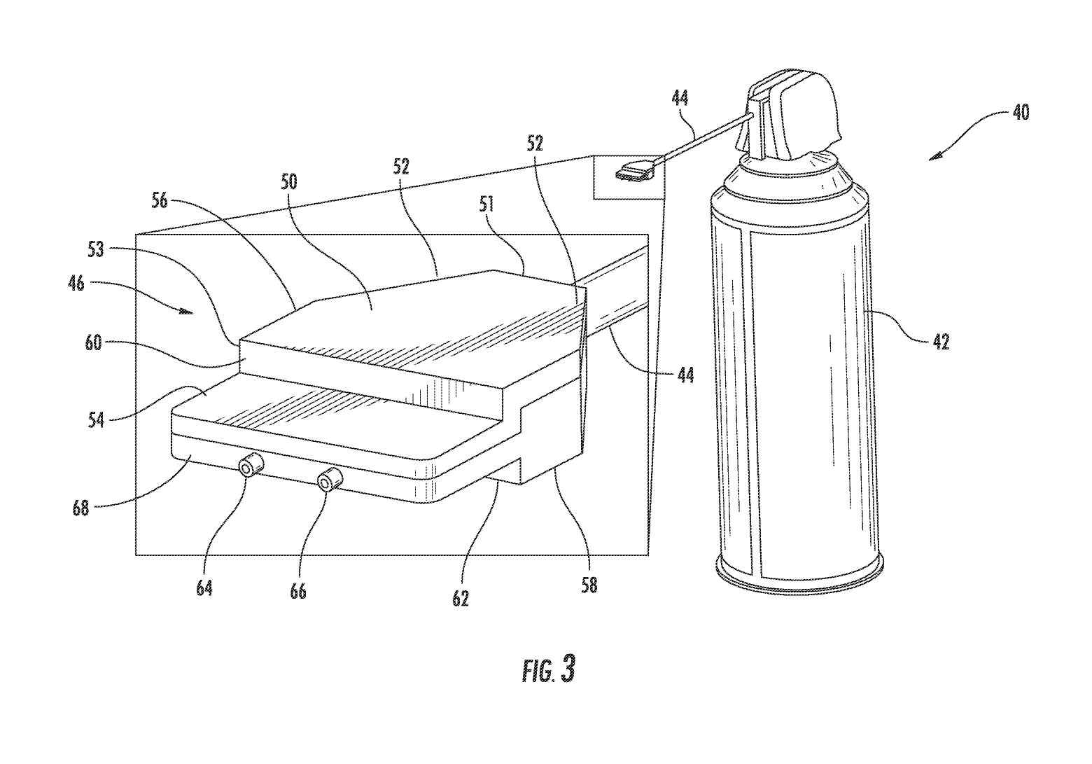

FIG. 3 is an isometric view of a fiber optic connector cleaning system 40 according to an embodiment of the disclosure. The cleaning system may include a compressed air (or other gas or cleaning solution) supply 42, a cleaning tip 46 and a tube 44 that provides fluid communication between the supply 42 and the cleaning tip 46. The supply 42 may be a compressed air supply 42 and as illustrated is an aerosol can 42. The term “air” used herein should be construed to include air, any other gas, or any appropriate cleaning medium or solution. An air pressure of the compressed air may be sufficient to clean the optical components 20, 22 and in particular the lens 32, 34 adequately, thoroughly, and properly. The air pressure of the compressed air may range from 5 pounds per square inch (PSI) to 50 PSI. The air pressure should be sufficiently low so as not to damage the optical components 20, 22 but sufficiently high to clear or blow away the optical components 20, 22 of contaminants. Fluid communication between the compressed air supply 42 and the cleaning tip 46 may be established by any means, including but not limited to rigid tubes, flexible tubes, hose, piping to name but a few. The means of fluid communication should be such that loss of air pressure from the compressed air supply 42 to the cleaning tip 46 is minimized. It is anticipated that some embodiments may not require a means to establish fluid communication and the compressed air supply 42 may connect directly the cleaning tip 46.

The cleaning tip 46 delivers compressed air to the fiber optic connector 10. The cleaning tip in the illustrated embodiment comprises a generally fan shaped body 50 having an orifice (not shown) arranged toward a first end 51 and a tongue 54 extending from a second end 53. The tube 44 may be connected to the cleaning tip 46 at the orifice. The fan shaped body has a generally flat upper surface 56 and a generally flat lower surface 58. The body tapers outward from about the first end 51 and toward the second end 53 via flared portions 52. The flared portion 52 may function to adjust the air pressure of the compressed air and may act as a diffuser or plenum to spread out and regulate the compressed air. An upper step 60 and a lower step 62 function to transition from the body 50 to the tongue 54. The tongue is sized and configured to be received within the end of either a male connector 12 or a female connector 14. Nozzles 62, 66 are arranged at an end 68 of the tongue 54. The nozzles 64, 66 are spaced from each other and oriented such that a flow of compressed air will be directed from the nozzles toward the optical components 20, 22 and in particular the lenses 30, 32 when the tongue is inserted into a fiber optic connector. Thus, the compressed air will clear the optical components 20, 22 of any contaminants. In some embodiments, only one nozzle may be required. A clearance may be provided between the tongue 54 and the case 16, 18 of the male or female connector 12, 14. The clearance may allow for contaminates and/or backwash to be exhausted from the connector 12, 14. Alternatively, the backwash can be channeled through the tongue or insert to exhaust behind the nozzle assembly. The male and female optical connectors may have internal shutters that close when the connectors are disconnected to shield the optical components at least partially from debris. The tongue 54 of the cleaning tip is configured to actuate or open any such shutters or other protective features within the connectors and to position the tips of the nozzles 64 and 66 very close to the optical surfaces to be cleaned.

A passageway (not shown) is disposed within the body 50 and tongue 54 of the cleaning tip 46. The passageway provides a conduit for the compressed air to flow through the cleaning tip 46 and exhaust through the nozzles 64, 66. The passageway may extend from the first end of the body 51 to the end 68 of the tongue 54. The passageway may be sized, shaped and optimized to control and meter the flow of compressed air. Any method may be used to size and shape the passageway such as computational fluid dynamic tools or experimentation.

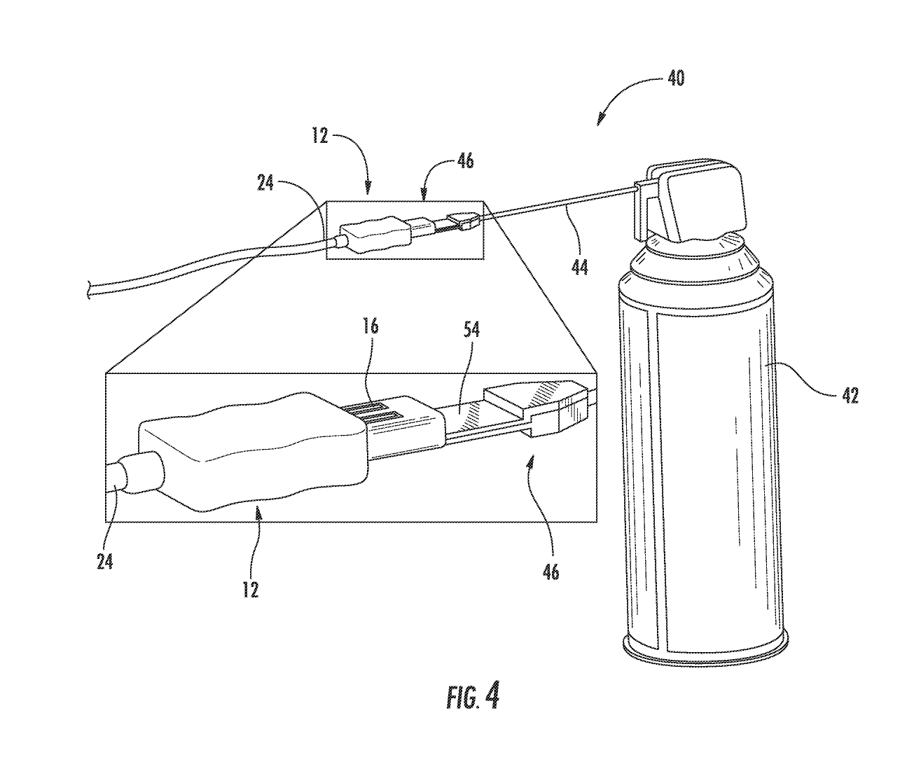

FIG. 4 is an isometric view of the cleaning system 40 showing the cleaning tip 46 being inserted into a male optical fiber connector 12. In this embodiment, the cleaning tip 46 may be disposed within the case or shroud 16 of the male connector 12. With reference to FIG. 2, the tongue 54 of the cleaning tip 46 is configured such that, when the tongue is fully inserted, nozzles 64, 66 are positioned close to and directed toward lens 32 thereby providing adequate flow of compressed air to clean the lens 32. In some embodiments, protrusions, indentations, or other features (not shown) may be required on the tongue 54 in order to open shutters or other protective features within the connector that normally shield the optical components 20.

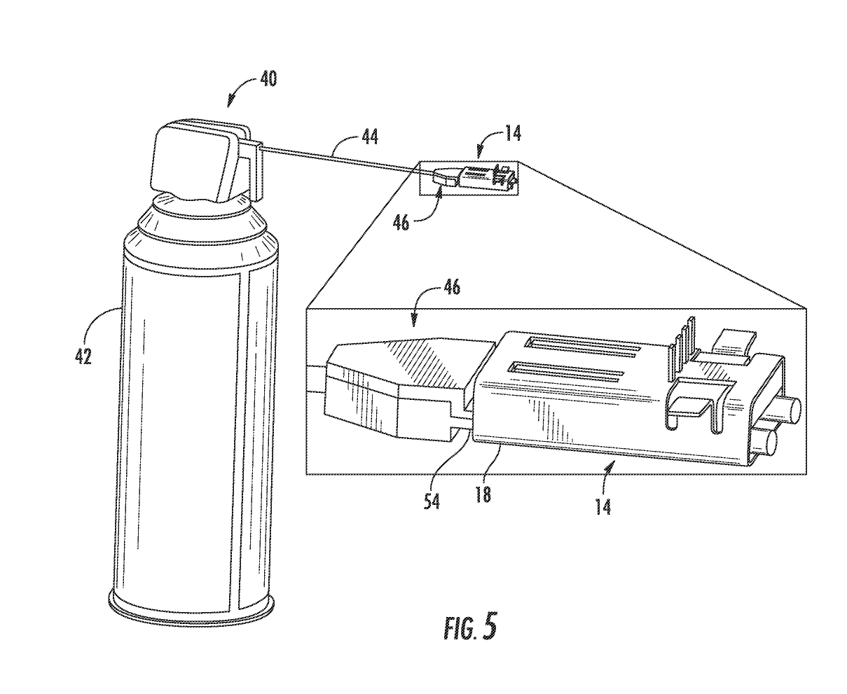

FIG. 5 is an isometric view of the cleaning system 40 showing the cleaning tip 46 inserted within a female fiber optic connector 14. The female portion may be connected to the end of another fiber optic cable, or it may be configured as a receptacle within a device such as a computer or a peripheral device to be connected to a computer. With reference to FIG. 2, the tongue 54 of the cleaning tip 46 slides within the case or shroud 18 such that nozzles 64, 66 are positioned close to and directed toward lens 34 and/or other optical components thereby providing adequate flow of compressed air to clean the lens 34. In some embodiments, protrusions, indentations, or other features (not shown) may be required on the tongue 54 in order to open shutters or other protective features within the connector that normally shield the optical components 22.

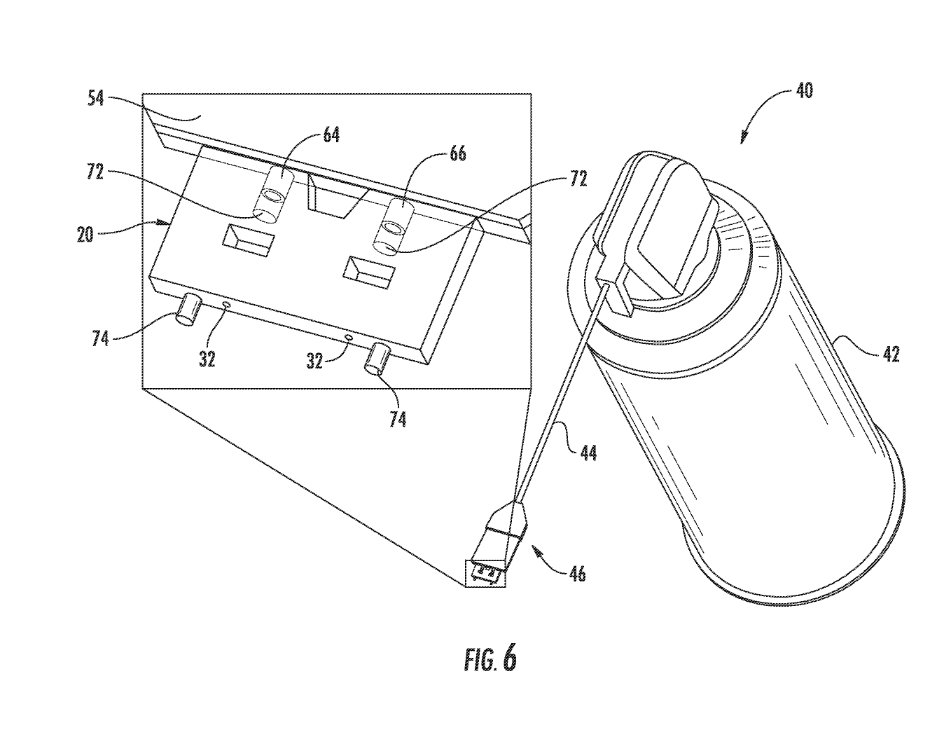

FIG. 6 is an isometric view of the cleaning system 40 showing the cleaning tip 46 disposed in a connector (outer components of which are removed for clarity) and positioned adjacent to optical components 20, which are contained within the case 16 (removed for clarity) of the connector 12. The nozzles 64, 66 are arranged approximately opposite the lenses 32. Compressed air may flow through channels 72 arranged within the optical components 20 in order to deliver compressed air to the lenses 32 and/or other optical components. Alignment horns 74 may aid in the assembly of the optical components 20 within the case 16 of the connector during fabrication of the connector.

It will be apparent to those skilled in the art that various modifications and variations can be made without departing from the spirit and scope of the invention exemplified herein, which is limited only by the claims.

What is claimed is:

1. A cleaning tip for delivering a cleaning medium to a fiber optic connector comprising:
a body having an orifice arranged near a first end for receiving compressed air;
a tongue extending from a second end of the body to a distal end and being configured to be inserted into a fiber optic connector;
at least one nozzle arranged near the distal end of the tongue; and
a passageway for delivering the compressed air, the passageway being within the body and tongue and extending from the first end of the body to the distal end of the tongue.

2. The cleaning tip of claim 1, wherein the tongue is sized and configured to be received by a male fiber optic connector.

3. The cleaning tip of claim 1, wherein the tongue is sized and configured to be received by a female fiber optic connector.

4. The cleaning tip of claim 1, wherein the at least one nozzle is positioned and arranged to direct a cleaning medium toward at least one lens in the fiber optic connector.

5. The cleaning tip of claim 4, wherein the at least one nozzle delivers the cleaning medium to remove contaminates from the at least one lens.

6. The cleaning tip of claim 4, wherein the at least one nozzle delivers the cleaning medium to a plurality of lens in the consumer electronic optical connector to remove contaminates from the plurality of lens.

7. The cleaning tip of claim 1, further comprising a second nozzle arranged near the distal end of the tongue adjacent the at least one nozzle.

8. The cleaning tip of claim 7, wherein the at least one nozzle and the second nozzle are directed toward corresponding lenses in the fiber optic connector.

9. The cleaning tip of claim 8, wherein the at least one nozzle and the second nozzle deliver the cleaning medium toward the corresponding lenses to remove contaminates therefrom.

10. The cleaning tip of claim 8, wherein the at least one nozzle and the second nozzle deliver compressed air.

11. The cleaning tip of claim 1, wherein the passageway diffuses a flow of cleaning medium from the first end of the body to the at least one nozzle.

12. The cleaning tip of claim 1, wherein the cleaning medium and contaminants are exhausted from the fiber optic connector.

13. The cleaning tip of claim 1, wherein the fiber optic connector is a universal serial bus optical connector.

14. A cleaning system for a lens of a consumer electronic optical connector, comprising:
a compressed air supply;
a cleaning tip in fluid communication with the compressed air supply, the cleaning tip comprising;
a cleaning tip body having an orifice for receiving compressed air from the compressed air supply;
a generally flat tongue extending from the cleaning tip body;
a nozzle arranged on an exterior surface of the tongue; and
a passageway within the cleaning tip body and tongue for delivering the compressed air, the passageway establishing fluid communication between the orifice and the nozzle.

15. The cleaning system as claimed in claim 14, wherein the compressed air supply is an aerosol compressed air supply.

16. The cleaning system as claimed in claim 14, wherein a hollow tube provides fluid communication between the compressed air supply and the cleaning tip.

17. The cleaning system of claim 14, wherein the tongue is sized and configured to be received by a male end of the consumer electronic optical connector.

18. The cleaning system of claim 14, wherein the tongue is sized and configured to be received by a female end of the consumer electronic optical connector.

19. The cleaning system of claim 14, wherein the nozzle is directed toward at least one lens in the consumer electronic optical connector.

20. The cleaning system of claim 19, further comprising a second nozzle and wherein the nozzle and the second nozzle deliver compressed air directed toward the at least one lens in the consumer electronic optical connector to remove contaminates from the at least one lens.

21. The cleaning system of claim 20, wherein the nozzle and the second nozzle deliver compressed air directed toward a plurality of lens in the consumer electronic optical connector to remove contaminates from the plurality of lens.

22. The cleaning system of claim 14, wherein the consumer electronic optical connector is a universal serial bus optical connector.
